(19) United States
(12) Patent Application Publication
(10) Pub. No.: US 2002/0071476 A1
(43) Pub. Date: Jun. 13, 2002

(54) Gain and phase distortion compensating method and transmitting apparatus therefor

(75) Inventor: Won Hyoung Park, Kyonggi-do (KR)

Correspondence Address: FLESHNER & KIM, LLP, P.O. Box 221200, Chantilly, VA, 20153-1200, US

(73) Assignee: LG ELECTRONICS INC.

(21) Appl. No.: 09/985,084

(22) Filed: Nov. 1, 2001

(30) Foreign Application Priority Data
Nov. 2, 2000 (KR) 2000/64864

(51) Int. Cl. H04B 1/69

(52) U.S. Cl. 375/130

(57) ABSTRACT

A method of compensating for a gain and phase distortion of a signal generated between transmission paths, and communication system therefor is disclosed. The phase of a digital signal is compensated for through phase analysis, and the strength of a transmitted power is measured with the minimum error to compensate for the gain and distortion of the signal and phase of the signal generated during the transmission procedure.

### BACKGROUND OF THE INVENTION

1. Field of the Invention

The present invention relates generally to a mobile communication system, and more particularly, to a method of compensating for a gain and phase distortion of a signal generated between transmission paths, and the transmitting apparatus therefor.

2. Background of the Related Art

Conventionally, in order to compensate for a phase distortion generated in transmission paths, a base station uses an analog filter. Signal transmission through such transmission paths is performed using the construction of FIG. 1.

FIG. 1 is a block diagram illustrating the construction of a conventional base station transmitter.

Referring to FIG. 1, the conventional base station transmitter includes a code division multiple access (CDMA) modem section 10 for spectrum-spreading input data (i.e., audio-coded digital audio signal) that has been separated into an I channel and Q channel and outputting the spectrum-spread data by sectors of the respective channels, a digital matching section 20 for summing by channels the spectrum-spread data of the I channel and Q channel outputted from the CDMA modem section 10, a baseband and intermediate frequency (IF) processing section 30 for converting the summed spectrum-spread digital signals of the I channel and Q channel into IF analog signals, and compensating for phase distortions of the analog signals, and a radio frequency (RF) processing section 40 for converting the IF analog signals into an RF signal for radio transmission.

At this time, the baseband and IF processing section 30 compensates for the distortion generated in the transmission paths according to the non-linear characteristic of temperature and circuit construction using an analog filter such as a phase equalizer after converting the digital signal into the analog signal.

However, it is difficult for such an analog filter to satisfy the linear phase characteristic and temperature characteristic. That is, since the analog filter itself has the non-linear characteristic and temperature characteristic, it becomes difficult to measure a phase error accurately.

Also, it is difficult to secure the stability and accuracy of the circuit for implementing the analog filter.

### SUMMARY OF THE INVENTION

Accordingly, the present invention is directed to a gain and phase distortion compensating method and apparatus and transmitter therefor that substantially obviates one or more problems due to limitations and disadvantages of the related art.

An object of the present invention is to provide a gain and phase distortion compensating method and transmitting apparatus therefor that can accurately measure and compensate for the gain and phase distortion.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus for compensating for a gain and phase distortion includes a first measuring device for measuring power levels of baseband signals of respective transmission channels and a phase difference between the baseband signals of the channels, a second measuring device for measuring a power level of a high frequency signal converted from the baseband signals, an analog-to-digital converter for converting the power level of the high frequency signal into a digital value, a controller for generating gain and phase control values of the respective transmission channels according to the baseband signals, digital value, and phase difference, a damper for adjusting gains of summed signals of the respective transmission channels according to the gain control value, and a phase equalizer for adjusting phases of the respective transmission channel signals according to the phase control value.

Preferably, the controller judges whether a proper gain is generated by comparing the digital value converted from the power level of the high frequency signal with the power level value of the baseband signal, generates the gain control value according to a result of judgement, and generates the phase control value by judging whether the phase difference between the baseband signals of the channels is within a range of a threshold value.

Preferably, the phase equalizer is for resetting polynomials according to the phase control value, and is implemented by a feedback response filter.

Preferably, the damper adjusts the gain of the summed IF signal of the respective transmission channel. The phase equalizer adjusts the phase of the baseband signal of the respective transmission channel according to the phase control value.

In another aspect of the present invention, a transmitter provided with a gain compensating apparatus according to the present invention includes a modem section for spectrum-spreading audio-coded digital signals and outputting the spectrum-spread signals by sectors of respective transmission channels, a matching section for summing by sectors of the respective channels outputs of the modem section and measuring power levels of summed baseband signals, and a radio processing section for judging whether a proper gain is generated by comparing the power levels of the baseband signals with a power level of a high frequency signal converted from the baseband signals, adjusting gains of intermediate frequency (IF) signals converted from the summed baseband signals according to a result of judgement, and converting the gain-adjusted signals into the high frequency signal.

In still another aspect of the present invention, a transmitter provided with a distortion compensating apparatus according to the present invention includes a modem section for spectrum-spreading audio-coded digital signals and outputting the spectrum-spread signals by sectors of respective transmission channels, a matching section for summing by sectors of the respective channels outputs of the modem section and measuring a phase error between summed baseband signals, and a radio processing section for judging whether the measured phase error is within a predetermined error range, adjusting phases of the summed baseband signals according to a result of judgement, and converting the phase-adjusted signals into the high frequency signal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating the construction of a conventional base station transmitter.

FIG. 2A and FIG. 2B are a block diagram illustrating the construction of a base station transmitter according to a first embodiment of the present invention.

FIG. 3 is a flowchart illustrating a gain compensating process according to the construction of FIG. 2A and FIG. 2B.

FIG. 4A and FIG. 4B are a block diagram illustrating the construction of a base station transmitter according to a second embodiment of the present invention.

FIG. 5 is a graph illustrating the response characteristic of a phase equalizer of FIG. 4A and FIG. 4B.

FIG. 6 is a view illustrating the construction of the phase equalizer of FIG. 4A and FIG. 4B.

FIG. 7 is a flowchart illustrating a phase distortion compensating process according to the construction of FIG. 4A and FIG. 4B.

FIG. 8A and FIG. 8B are a block diagram illustrating the construction of a base station transmitter according to a third embodiment of the present invention.

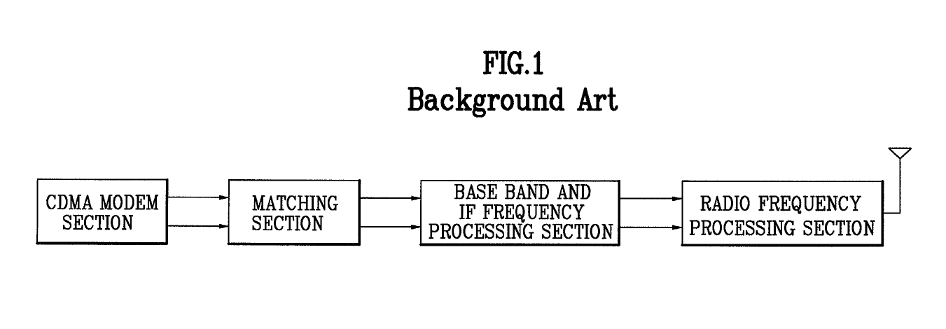

### DETAILED DESCRIPTION OF THE INVENTION

Reference will now be made in detail to the preferred embodiments of the present invention, examples of which are illustrated in the accompanying drawings.

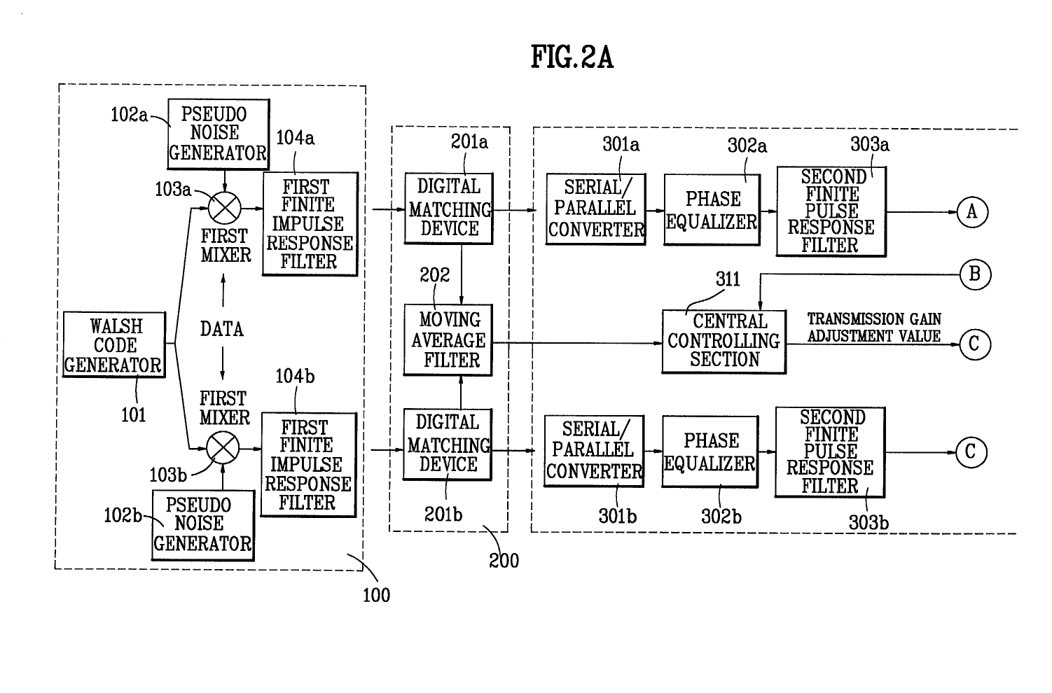

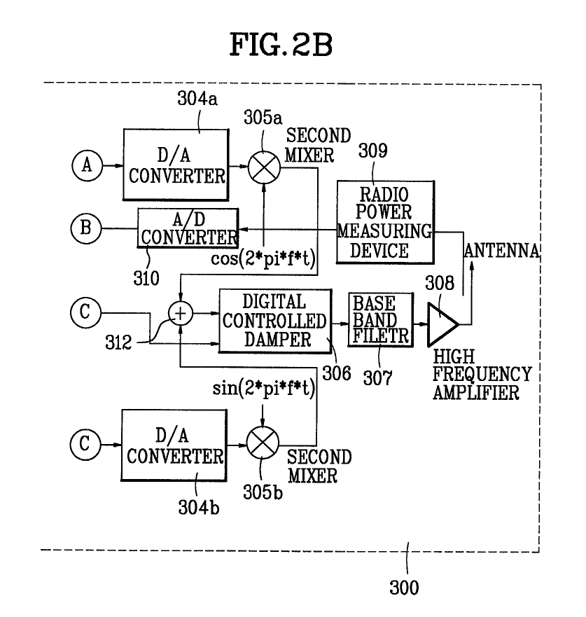

FIG. 2A and FIG. 2B are a block diagram illustrating the construction of a base station transmitter according to a first embodiment of the present invention.

Referring to FIG. 2A and FIG. 2B, the base station transmitter according to the first embodiment of the present invention includes a CDMA modem section 100 for spectrum-spreading input data (i.e., audio-coded digital audio signal) that has been separated into an I channel and Q channel, and outputting the spectrum-spread data by sectors of the respective channels, a digital matching section 200 for summing by channels the spectrum-spread data of the I channel and Q channel outputted from the CDMA modem section 100 and measuring powers of the respective summed channel baseband signals, a baseband and IF processing section 300 for compensating for phase distortions of the respective summed spectrum-spread digital signals of the I channel and Q channel and converting the distortion-compensated signals into IF analog signals, and a radio frequency (RF) processing section 300 for converting the IF analog signals into a high frequency signal for radio transmission.

The data inputted through I channel and Q channel are independently processed on the respective channel transmission paths. Accordingly, in explaining the detailed construction of the base station transmitter hereinafter, one channel transmission path will be exemplified on the assumption that the other channel transmission path has the same construction. However, the respective channel signals converted into the IF signals are summed into one signal, and then converted into a high frequency signal by the radio frequency processing section 300.

The CDMA modem section 100 includes a Walsh code generator 101 for generating a Walsh code, PN code generators 102a and 102b for generating pseudo noise (PN) codes of I channel and Q channel, the first mixers 103a and 103b for spectrum-spreading the input data by mixing the data, and the first finite impulse response filters 104a and 104b for generating impulse response signals (i.e., spectrum-limited signals) of the spectrum-spread signals.

The digital matching section 200 includes digital matching devices 201a and 201b for summing the I-channel and Q-channel impulse response signals provided from the CDMA modem section 100 by sectors of the I channel and Q channel (i.e., respective channels), and a moving average filter 202, measuring device for measuring powers of the impulse response signals (i.e., baseband signals) summed in the respective channels.

The baseband and RF processing section 300 includes serial/parallel converters 301a and 301b for converting the impulse response signals summed by sectors in the respective channels into parallel signals of the respective channels, phase equalizers 302a and 302b for compensating for phase distortions of the parallel signals, the second finite pulse response filters 303a and 303b for generating impulse response signals (i.e., spread-limited signals) of the phase-distortion-compensated signals, digital-to-analog (D/A) converters 304a and 304b for converting the impulse response signals into analog signals, second mixers 305a and 305b for converting the analog signals into IF signals, and a summer 312 for summing the IF signals of the I channel and Q channel, a digital controlled damper 306 for adjusting the gains of the summed IF signals according to an external control signal, a baseband pass filter 307 for removing spurious signals of the gain-adjusted signals, a high frequency amplifier 308 for amplifying an output signal of the baseband pass filter 307 to apply the amplified signal to a transmission antenna, a radio power measuring device 309 for measuring the high frequency power by coupling the applied signal, an analog-to-digital (A/D) converter 310 for converting the high frequency power into a digital signal, and a central controlling section 311 for judging whether the gain is normally generated during the transmission process by comparing the power of the digital signal with the resultant power of the moving average filter 202 and generating a transmission gain adjustment value, i.e., the external control signal provided to the digital controlled damper 306, according to a result of judgment.

The operation of the base station transmitter of FIG. 2A and FIG. 2B is as follows.

The first mixer 103a or 103b spectrum-spreads the input data using the Walsh code (i.e., base station identification code) and the PN code (i.e., spreading code) provided from the Walsh code generator 101 and the PN code generator 102a or 102b.

The first finite impulse response filter 104a or 104b generates the impulse response signal from the spectrum-spread signal, i.e., removes an out-band signal generated during the spreading process.

The CDMA modem section 100, that includes the first mixer 103a or 103b and the finite impulse response filter 104a or 104b, outputs the impulse response signals through the above process by sectors (generally, the sectors are classified into alpha, beta, and gamma sectors).

The digital matching device 201a or 201b sums the respective sector impulse response signals, and output the summed response signals by sub-channels of I0 and I1 (or Q0 and Q1). The moving average filter 202 measures the power level of the summed response signal (i.e., power of the baseband signal).

The serial/parallel converter 301a or 301b converts the I0 or I1 (or Q0 or Q1) channel signal into I or Q parallel signal.

The phase equalizer 302a or 302b compensates for the phase distortion of the parallel signal, and the second finite pulse response filter 303a or 303b generates the impulse response signal of the phase-distortion-compensated signal, i.e., spectrum-limited signal. The D/A converter 304a or 304b converts the impulse response signal into the analog signal. The second mixer 305a or 305b converts the analog signal into the IF signal.

The summer 312 sums the IF signals generated in the respective channel transmission paths as described above.

The digital controlled damper 306 adjusts the gain of the summed signal according to the external gain control value (provided from the central controlling section 311).

The baseband pass filter 307 removes the spurious signal of the gain-controlled signal, and the high frequency amplifier 308 amplifies the signal from which the spurious signal is removed, and applies the amplified signal to the transmission antenna.

At this time, the radio power measuring device 309 measures the power of the high frequency signal by coupling the signal applied to the transmission antenna.

The A/D converter 310 converts the power level of the high frequency signal into the digital signal to provide the converted digital signal to the central controlling section 311.

The central controlling section 311 compares the power level of the digital high-frequency signal with the power level of the baseband signal provided from the moving average filter 202. The central controlling section 311 has a table for judging whether the ratio of the power level of the high frequency signal to the power level of the baseband signal is proper, i.e., whether a proper level of gain has been produced during the process in the transmission paths.

According to a result of judgment as above, the central controlling section 311 generates the transmission gain adjustment value to provide the adjustment value to the digital controlled damper 306.

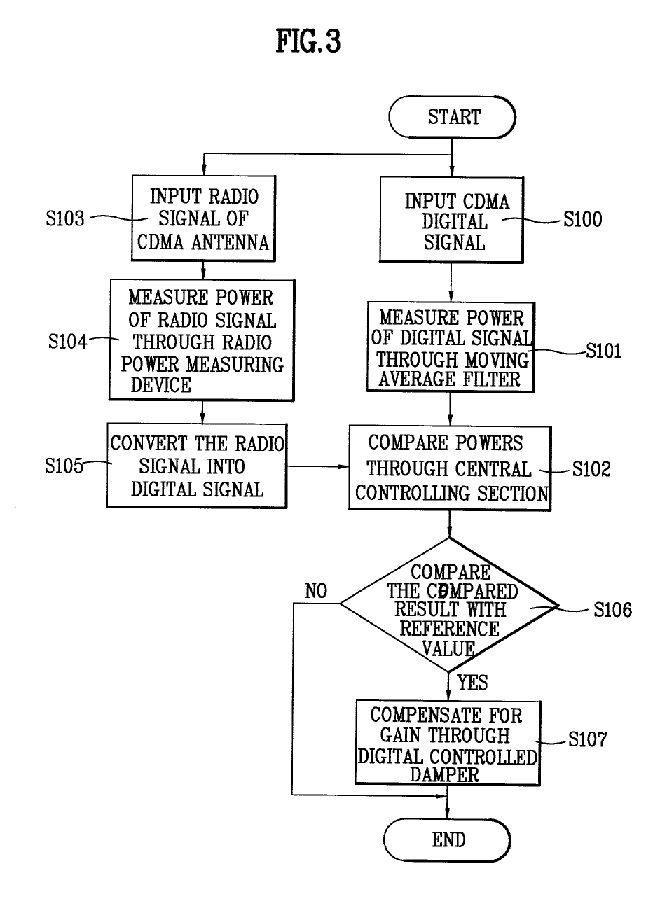

FIG. 3 is a flowchart illustrating a gain compensating process according to the construction of FIG. 2A and FIG. 2B.

The moving average filter 202 is designed as a digital filter in the form of a finite impulse filter, and the transfer function of this filter satisfies the following equation 1.

$${H}_{ma} ( {E}^{jw} ) = \frac{1}{M + 1} \cdot \frac{sin ( w ( M + 1 ) / 2 )}{sin ( w / 2 )} \cdot {e}^{jwM / 2} \vert w \vert < π \qquad [ Equation 1 ]$$

In the equation 1, M means the degree of the filter, and w is 2*pi*f that means the respective frequency.

Referring to FIG. 3, if the CDMA digital signal is inputted from the digital matching device 201a or 201b (step S100), the moving average filter 202 measures the power level of the digital input signal (step S101).

The measured value is inputted to the central controlling section 311 (step S102).

Meanwhile, if the power level of the high frequency signal measured by the radio power measuring device 309 (that is measured by coupling the signal applied to the transmission antenna) is converted into the digital signal and then inputted to the central controlling section 311 (steps S103˜S105), the central controlling section 311 compares the power level of the measured baseband signal with the power level of the high frequency signal (step S 106), and generates the transmission gain adjustment value by comparing the difference value therebetween with a reference value (step S107).

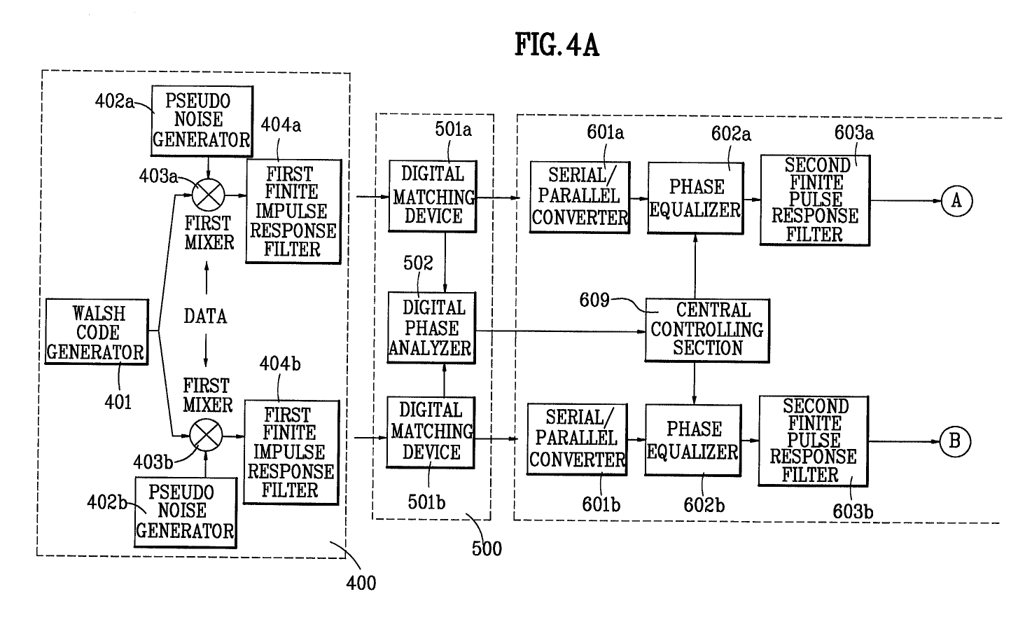

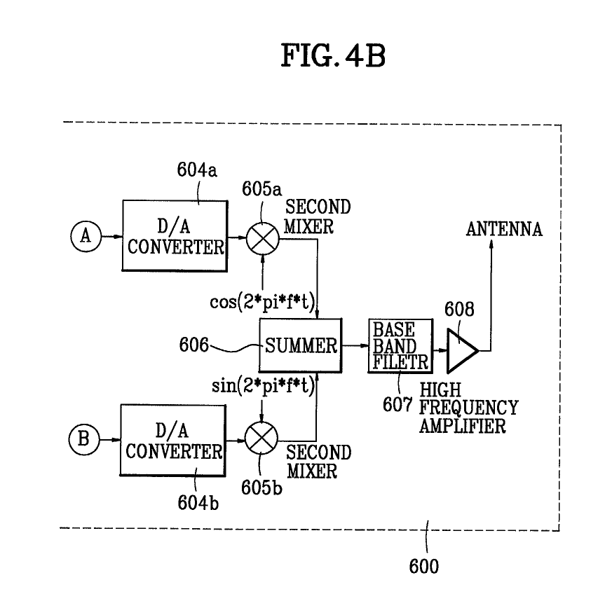

FIG. 4A and FIG. 4B are a block diagram illustrating the construction of a base station transmitter according to a second embodiment of the present invention.

Referring to FIG. 4A and FIG. 4B, the base station transmitter according to the second embodiment of the present invention includes a CDMA modem section 400 for spectrum-spreading input data (i.e., audio-coded digital audio signal) that has been separated into an I channel and Q channel and outputting the spectrum-spread data by sectors of the respective channels, a digital matching section 500 for summing by channels the spectrum-spread data of the I channel and Q channel outputted from the CDMA modem section 400 and measuring powers of the respective summed channel baseband signals, and a baseband and RF processing section 600 for compensating for phase distortions of the respective summed spectrum-spread digital signals of the I channel and Q channel according to an external control signal and converting the distortion-compensated signals into IF and high-frequency analog signals.

The CDMA modem section 400 includes a Walsh code generator 401 for generating a Walsh code, PN code generators 402a and 402b for generating pseudo noise (PN) codes of I channel and Q channel, the first mixers 403a and 403b for spectrum-spreading the input data by mixing the input data, and the first finite impulse response filters 404a and 404b for generating impulse response signals (i.e., spectrum-limited signals) of the spectrum-spread signals.

The digital matching section 500 includes digital matching devices 501a and 501b for summing the I-channel and Q-channel impulse response signals provided from the CDMA modem section 400 by sectors of the I channel and Q channel (i.e., respective channels), and a digital phase analyzer 502, measuring device for measuring phase errors of the impulse response signals (i.e., baseband signals) summed in the respective channels.

The baseband and RF processing section 600 includes serial/parallel converters 601a and 601b for converting the impulse response signals summed by sectors in the respective channels into parallel signals of the respective channels, phase equalizers 602a and 602b for compensating for phase distortions of the parallel signals according to the external control signal, the second finite pulse response filters 603a and 603b for generating impulse response signals (i.e., spread-limited signals) of the phase-distortion-compensated signals, digital-to-analog (D/A) converters 604a and 604b for converting the impulse response signals into analog signals, second mixers 605a and 605b for converting the analog signals into IF signals, and a summer 606 for summing the IF signals of the I channel and Q channel, a baseband pass filter 607 for removing spurious signals of the summed IF signals, and a high frequency amplifier 608 for amplifying an output signal of the baseband pass filter 607 to apply the amplified signal to a transmission antenna.

The operation of the base station transmitter of FIG. 4A and FIG. 4B is as follows.

The first mixer 403a or 403b spectrum-spreads the input data using the Walsh code (i.e., base station identification code) and the PN code (i.e., spreading code) provided from the Walsh code generator 401 and the PN code generator 402a or 402b.

The first finite impulse response filter 404a or 404b generates the impulse response signal from the spectrum-spread signal, i.e., removes an out-band signal generated during the spreading process.

The CDMA modem section 400, that includes the first mixer 403a or 403b and the finite impulse response filter 404a or 404b, outputs the impulse response signals through the above process by sectors (generally, the sectors are classified into alpha, beta, and gamma sectors).

The digital matching device 501a or 501b sums the respective sector impulse response signals, and output the summed response signals by sub-channels of I0 and I1 (or Q0 and Q1). The digital phase analyzer 502 measures the phase errors of the summed impulse response signals inputted from the digital matching devices 501a and 501b. At this time, the receiving end can properly restore the channel signals summed and transmitted to the receiving end only when the phase differences of the I channel and Q channel is within the predetermined error range.

The serial/parallel converter 601a or 601b converts the I0 or I1 (or Q0 or Q1) channel signal into I or Q channel parallel signal.

The phase equalizer 602a or 602b compensates for the phase distortion of the parallel signal according to the external control signal, which is generated as follows. If the phase differences of the I channel and Q channel measured by the digital phase analyzer 502 are inputted to the central controlling section 609, the central controlling section 609 provides to the phase equalizers 602a and 602b the phase adjustment value, i.e., the external control signal, so that the phase differences are within the predetermined error range. This external control signal changes polynomials (i.e., polynomials of a shifting register) of the phase equalizers 602a and 602b. For the change of the polynomials, the phase equalizers 602a and 602b are implemented by feedback response filters that can reset polynomials.

The second finite pulse response filter 603a or 603b generates the impulse response signal of the phase-distortion-compensated signal, i.e., spectrum-limited signal. The D/A converter 604a or 604b converts the impulse response signal into the analog signal. The second mixer 605a or 605b converts the analog signal into the IF signal.

The summer 606 sums the IF signals generated in the respective channel transmission paths as described above. The baseband pass filter 607 removes the spurious signal of the phase-distortion-compensated signal, and the high frequency amplifier 608 amplifies the signal from which the spurious signal is removed to apply the amplified signal to the transmission antenna.

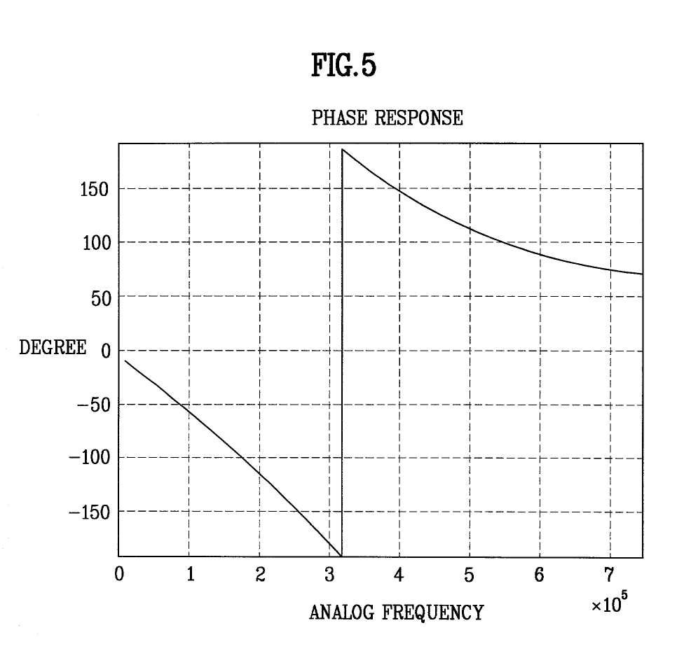

FIG. 5 is a graph illustrating the response characteristic of the phase equalizer of FIG. 4A and FIG. 4B.

The response characteristic of the phase equalizer illustrated in FIG. 4A and FIG. 4B should satisfy the following equation 2.

$$Hpe ( w ) = K \frac{{w}^{2} + j \cdot α \cdot w \cdot {w}_{0} + {w}_{0}^{2}}{{w}^{2} - j \cdot α \cdot w \cdot {w}_{0} - {w}_{0}^{2}} \qquad [ Equation 2 ]$$

In the equation 2, K is a certain gain, j is \sqrt{−1}, α is a damping factor of 1.36, ω is a radian frequency, ω₀ represents 2π*3.15*10⁵. If the above equation is satisfied, the graph of the phase characteristic as shown in FIG. 5 is produced.

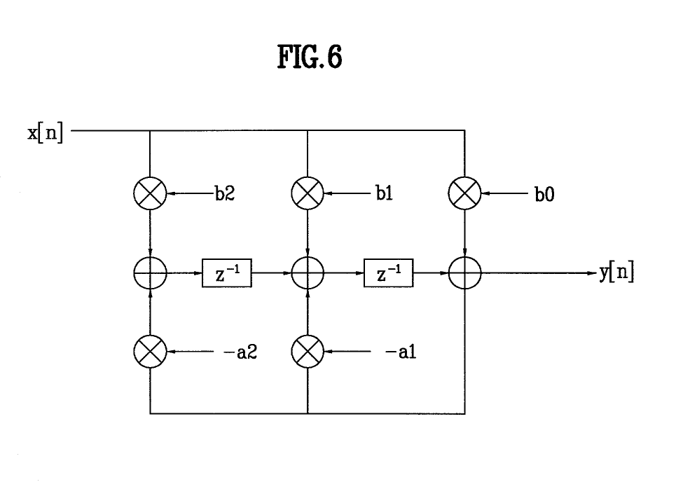

FIG. 6 is a view illustrating the construction of the phase equalizer of FIG. 4A and FIG. 4B.

The phase equalizer has the construction implemented as a digital filter, and satisfies the transfer function of the following equation 3.

$$\begin{matrix}Hpe ( w ) = \frac{0.57719 - 1.44945 {z}^{- 1} + {z}^{- 2}}{1 + 1.44945 {z}^{- 1} + 0.57719 {z}^{- 2}} \\ Hpe ( w ) = \frac{{b}_{0} - {b}_{1} {z}^{- 1} + {b}_{2} {z}^{- 2}}{1 + {a}_{1} {z}^{- 1} + {a}_{2} {z}^{- 2}}\end{matrix} \qquad [ Equation 3 ]$$

In the equation 3, a₁, a₂, b₀, bᵢ, and b₂ are polynomials that constitute the phase equalizer, and can be designed by obtaining a pole and zero in FIG. 3.

In FIG. 6, z⁻¹ represents a shift register.

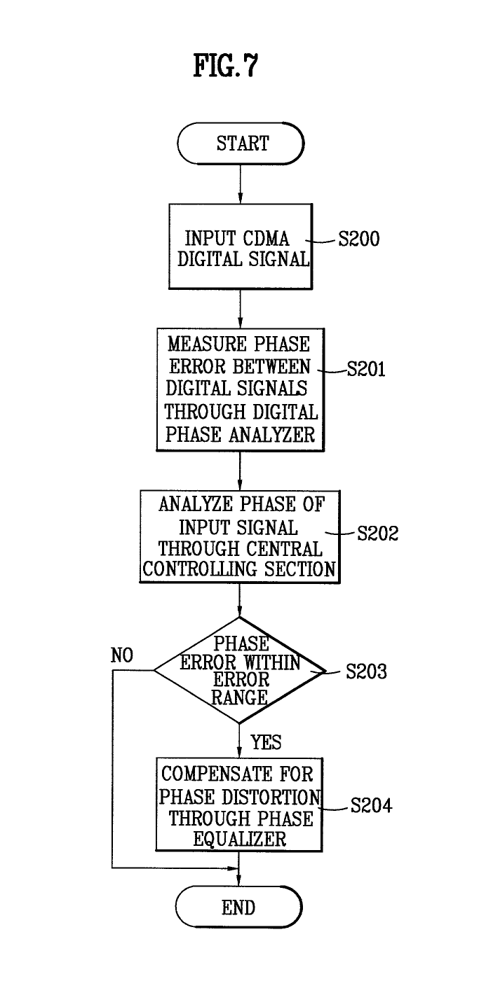

FIG. 7 is a flowchart illustrating a phase distortion compensating process according to the construction of FIG. 4A and FIG. 4B.

First, if the baseband signals are inputted from the digital matching devices 501a and 501b (step S200), the digital phase analyzer 502 measures the phase difference between the input signals (step S201).

The measured phase difference value is inputted to the central controlling section 609.

The central controlling section 609 compares the input phase difference value with the value of the predetermined error range (step S202).

If the phase difference deviates from the predetermined range as a result of comparison (step S 203), the central controlling section generates the control signal for changing the polynomials of the phase equalizers 602a and 602b, so that the phase distortion compensation is performed (step S204).

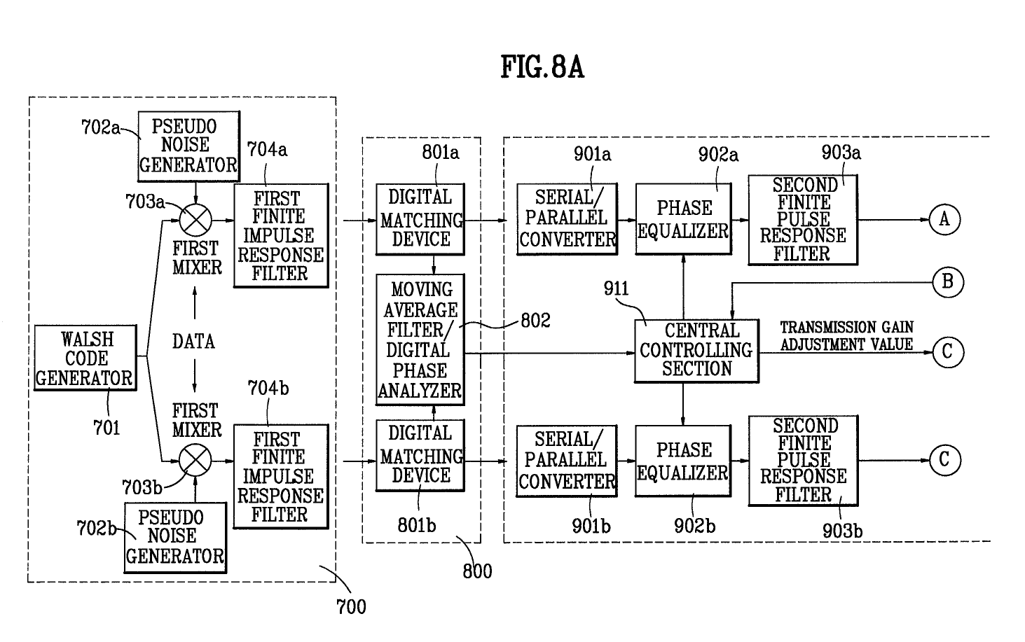

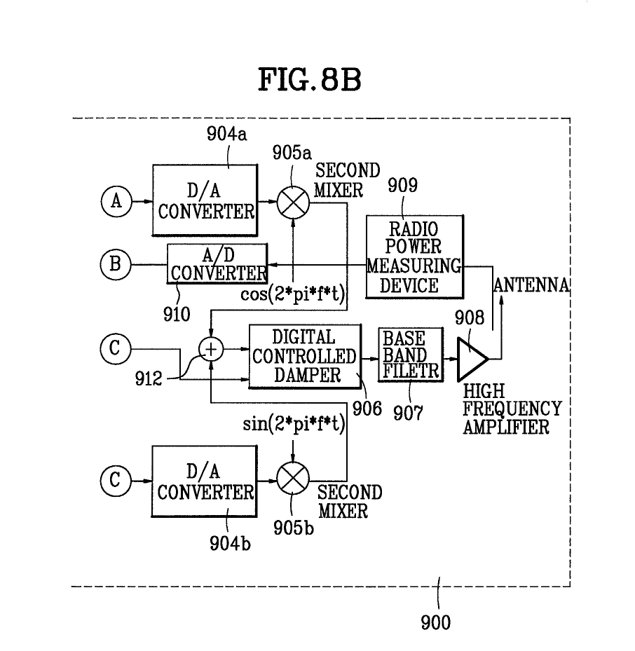

FIG. 8A and FIG. 8B are block diagrams illustrating the construction of a base station transmitter according to a third embodiment of the present invention.

FIG. 8A and FIG. 8B have the same performance and configuration with those of FIG. 2A and FIG. 2B.

Exceptionally, in FIG. 8A, a moving average filter 202 and a digital phase analyzer 502 of FIG. 2A and FIG. 4A are implemented as a measuring device 802. In the same manner as the preferred embodiments above, the measuring device 802 measures the power of impulse response signals (baseband signals) summed in each channel of digital matching devices 801a and 801b, and measures phase errors of the impulse response signals summed in each channel.

The central controlling section 609 provides a transmission gain adjustment value to a digital controlled damper 906 in accordance with the measured results of the measuring device 802. The central controlling section 609 also provides a phase control value (or phase error compensated value) to phase equalizers 902a and 902b in each channel.

The central controlling section 609 judges whether a proper transmission gain value is generated by comparing the digital value converted from the power level of the high frequency signal which is measured by a radio power measuring device 909 with the power level of the baseband signal, generates transmission gain adjustment value according to a result of judgement, and generates the phase control value by judging whether the phase difference between the baseband signals of the channels is within a range of a threshold value.

Therefore, polynomials(coefficients of shifting register) of the phase equalizers 902a and 902b have varied values in accordance with the phase error compensated value. The phase equalizers 902a and 902b are implemented as a feedback response filter that can reset coefficients to vary the polynomials.

Consequently, according to the two embodiments of the present invention as described above, the phase of the digital signal is compensated for by analyzing the phase, and the distortion and gain of the signal and phase generated during the transmission process are compensated for by measuring the strength of the transmitted power with the minimum error.

As described above, according to the mobile communication transmitting system of the present invention, the transmission gain and temperature compensating circuit is digitally constructed within the limited error, and thus the estimation and accuracy of the error can be greatly improved.

Also, since the phase equalizer that controls the phase characteristic of the base station transmitter is implemented using the digital filter, the modulation accuracy of the modulator can be greatly improved.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An apparatus for compensating for a gain and phase distortion comprising:
a first measuring device for measuring power levels of baseband signals of respective transmission channels and a phase difference between the baseband signals of the channels;
a second measuring device for measuring a power level of a high frequency signal converted from the baseband signals; and
a controller for generating gain and phase control values of the respective transmission channels according to the power levels of the baseband signal and the high frequency signal, and the phase difference;
a damper for adjusting gains of summed signals of the respective transmission channels according to the gain control value; and
a phase equalizer for adjusting phases of the respective transmission channel signals according to the phase control value.

2. The apparatus as claimed in claim 1, wherein the controller judges whether a proper gain is generated by comparing the power level of the high frequency signal with the power level of the baseband signal, and generates the gain control value according to a result of judgment.

3. The apparatus as claimed in claim 1, further comprising:
an analog-to-digital converter for converting the power level of the high frequency signal into a digital value and providing the digital value to the controller.

4. The apparatus as claimed in claim 1, wherein the damper adjusts gains of summed intermediate frequency signals of the respective transmission channels.

5. The apparatus as claimed in claim 1, wherein the controller generates the phase control value by judging whether the phase difference between the baseband signals of the channels is within a range of a threshold value.

6. The apparatus as claimed in claim 1, wherein the phase equalizer adjusts the phase of the baseband signal of the respective transmission channel according to the phase control value.

7. The apparatus as claimed in claim 1, wherein the phase equalizer is implemented by a feedback response filter that can reset polynomials.

8. An apparatus for compensating for a gain and phase distortion comprising:
a first measuring device for measuring power levels of baseband signals of respective transmission channels and a phase difference between the baseband signals of the channels;
a second measuring device for measuring a power level of a high frequency signal converted from the baseband signals;
an analog-to-digital converter for converting the power level of the high frequency signal into a digital value;
a controller for generating gain and phase control values of the respective transmission channels according to the baseband signals, the digital value, and the phase difference;
a damper for adjusting gains of summed signals of the respective transmission channels according to the gain control value; and
a phase equalizer for adjusting phases of the respective transmission channel signals according to the phase control value.

9. The apparatus as claimed in claim 8, wherein the controller judges whether a proper gain is generated by comparing the digital value converted from the power level of the high frequency signal with the power level of the baseband signal, generates the gain control value according to a result of judgement, and generates the phase control value by judging whether the phase difference between the baseband signals of the channels is within a range of a threshold value.

10. The apparatus as claimed in claim 8, wherein the phase equalizer is for resetting polynomials according to the phase control value, and is implemented by a feedback response filter.

11. The apparatus as claimed in claim 8, wherein the damper adjusts the gain of the summed intermediate frequency signal of the respective transmission channel.

12. The apparatus as claimed in claim 8, wherein the phase equalizer adjusts the phase of the baseband signal of the respective transmission channel according to the phase control value.

13. A transmitter provided with a gain compensating apparatus, the transmitter comprising:
a modem section for spectrum-spreading audio-coded digital signals and outputting the spectrum-spread signals by sectors of respective transmission channels;
a matching section for summing by sectors of the respective channels outputs of the modem section and measuring power levels of summed baseband signals; and
a radio processing section for judging whether a proper gain is generated by comparing the power levels of the baseband signals with a power level of a high frequency signal converted from the baseband signals, adjusting gains of intermediate frequency signals converted from the summed baseband signals according to a result of judgement, and converting the gain-adjusted signals into the high frequency signal.

14. A transmitter provided with a distortion compensating apparatus, the transmitter comprising:
a modem section for spectrum-spreading audio-coded digital signals and outputting the spectrum-spread signals by sectors of respective transmission channels;
a matching section for summing by sectors of the respective channels outputs of the modem section and measuring a phase error between summed baseband signals; and
a radio processing section for judging whether the measured phase error is within a predetermined error range, adjusting phases of the summed baseband signals according to a result of judgement, and converting the phase-adjusted signals into a high frequency signal.

15. A method of compensating for a gain and phase distortion comprising the steps of:
(a) measuring power levels of baseband signals of respective transmission channels and a phase difference between the baseband signals of the channels;
(b) measuring a power level of a high frequency signal converted from the baseband signals; and
(c) generating gain and phase control values of the respective transmission channels according to the power levels of the baseband signal and the high frequency signal, and the phase difference;
(d) adjusting gains of summed signals of the respective transmission channels according to the gain control value; and
(e) adjusting phases of the respective transmission channel signals according to the phase control value.

16. The method as claimed in claim 15, further comprising the steps of:
judging whether a proper gain is generated by comparing a value converted from the power level of the high frequency signal with the power level value of the baseband signal; and
generating the gain control value according to a result of judgment.

17. The method as claimed in claim 15, wherein gains of summed intermediate frequency signals of the respective transmission channels are adjusted according to the gain control value.

18. The method as claimed in claim 15, further comprising the steps of generating the phase control value by judging whether the phase difference between the baseband signals of the channels is within a range of a threshold value.

19. The method as claimed in claim 15, further comprising the step of resetting polynomials for phase adjustment according to the phase control value.

20. A method of compensating for a gain and phase distortion comprising the steps of:
(a) measuring power levels of baseband signals of respective transmission channels and a phase difference between the baseband signals of the channels;
(b) measuring a power level of a high frequency signal converted from the baseband signals;
(c) converting the power level of the high frequency signal into a digital value;
(d) generating gain and phase control values of the respective transmission channels according to the power levels of the converted digital value and the baseband signals, and the phase difference;
(e) adjusting gains of summed signals of the respective transmission channels according to the gain control value; and
(f) adjusting phases of the respective transmission channel signals according to the phase control value.

21. The method as claimed in claim 20, further comprising the steps of:
judging whether a proper gain is generated by comparing the converted digital value with the power level of the baseband signal, and generating the gain control value according to a result of judgement; and
judging whether the phase difference between the baseband signals of the channel is within a range of a threshold value, and generating the phase control value according to a result of judgment.

22. The method as claimed in claim 20, further comprising the step of resetting polynomials for phase adjustment according to the phase control value.

23. The method as claimed in claim 20, wherein the gain of the summed intermediate frequency signal of the respective transmission channel is adjusted.

24. The method as claimed in claim 20, wherein the phase of the baseband signal of the respective transmission channel is adjusted according to the phase control value.

25. A method of compensating for a gain, comprising the steps of:
spectrum-spreading audio-coded digital signals and outputting the spectrum-spread signals by sectors of respective transmission channels;
summing by sectors of the respective channels the output signals and measuring power levels of summed baseband signals;
judging whether a proper gain is generated by comparing the power levels of the baseband signals with a power level of a high frequency signal converted from the baseband signals;
adjusting gains of intermediate frequency signals converted from the summed baseband signals according to a result of judgement; and
converting the gain-adjusted signals into the high frequency signal.

26. A method of compensating for a distortion, comprising the steps of:
spectrum-spreading audio-coded digital signals and outputting the spectrum-spread signals by sectors of respective transmission channels;
summing by sectors of the respective channels outputs of the modem section, and measuring a phase error between summed baseband signals;
judging whether the measured phase error is within a predetermined error range;
adjusting phases of the summed baseband signals according to a result of judgement; and
converting the phase-adjusted signals into a high frequency signal.
